(19) United States
(12) Patent Application Publication
(10) Pub. No.: US 2011/0127147 A1
(43) Pub. Date: Jun. 2, 2011

(54) DEVICE FOR MONITORING THE STATE OF A SAFETY DEVICE ON A MACHINE

(76) Inventors: Tobias König, Boblingen (DE); Erik Bächle, Filderstadt (DE)

(21) Appl. No.: 12/737,492

(22) PCT Filed: Nov. 5, 2009
(86) PCT No.: PCT/EP2009/007926

§ 371 Date: Jan. 19, 2011

(30) Foreign Application Priority Data
Nov. 6, 2008 (DE) 10 2008 057 223.3

(51) Int. Cl. H01H 9/28

(52) U.S. Cl. 200/43.16

(57) ABSTRACT

The invention relates to a device (1) for monitoring the state of a safety device (2) of a machine (4), in particular a safety switch for monitoring the closed state of a safety door or the like, the device (1) having a switch housing (22, 24) and an actuator (8), which, when the safety device (2) is closed, cooperates with a switch actuating element (14) movably mounted in the switch housing (22, 24) and the closed state of the safety device (2) can be signaled thereby, and the device (1) having a locking device by which the closed state of the safety device (2) can be releasably locked, characterized in that by applying excessive force to the actuator (8) against the action of the locking device, the switch actuating element (14) can be brought into a fail-safe position, from which the switch actuating element (14) can no longer be transferred by the actuator (8) into a position in which the device (1) signals the locked state of the safety device (2), and the device (1) signals the unlocked state of the safety device (2) in this fail-safe position of the switch actuating element.

The invention relates to a device for monitoring the state of a safety device on a machine, in particular a safety switch for monitoring the closed state of a safety door or the like, with a guard locking function for the safety device.

DE 43 28 297 C1 discloses a safety switch with a switch head, into which an actuator, which is mounted, for example, on a safety door of a safety device, can be inserted and, in so doing, turns a switch wheel. The interior of the switch housing has a switch plunger that is held in engagement with the peripheral surface of the switch wheel. At an angle of rotation that corresponds to the closed position of the safety door, the switch plunger snap-locks into a detent recess, which is provided for this purpose on the peripheral surface of the switch wheel, and, in so doing, closes a contact pair. In this way, the inserted state of the actuator and, hence, the closed position of the safety door can be electrically signaled.

For many applications, for example, in the case of protective hoods on machine tools or the like, it is required that the safety switch also provide a guard locking function, that is, that the actuator can be locked in the switch head, in particular can be locked in such a way that it cannot be driven out of the switch head, as a result of which the safety device can be locked in the closed state. Thus, in the safety switch known from the prior art, the switch plunger is held in the detent recess subject to a spring force or a magnetic force, so that consequently a rotational movement of the cam disk is blocked. If the safety door is forced with a significant amount of force when the safety device is in the locked and closed state, then the safety switch may be damaged and may, therefore, malfunction, as a result of which it would no longer be possible to guarantee the safety function of the safety switch.

The object of the invention is to provide a generic device that overcomes the disadvantages of the prior art. In particular, the intent is to provide a device that also guarantees the safety function even under the influence of unacceptably high actuating forces. Moreover, the intent is to simplify the production, assembly, and maintenance of the device, thus reducing the time and costs.

This object is achieved by the device specified in claim 1. Special embodiments of the invention are defined in the dependent claims.

One embodiment achieves this object with a device for monitoring the state of a safety device on a machine, in particular, with a safety switch for monitoring the closed state of a safety door or the like. In this case, the device has a switch housing and an actuator, which in the closed state of the safety device interacts with a switch actuating element, which is mounted in a moveable manner in the switch housing; and, thus, the closed state of the safety device can be signaled. The device has a guard locking device, by means of which the closed state of the safety device can be locked in a releasable manner. By applying excessive force to the actuator against the effect of the guard locking device, the switch actuating element can be moved into a fail-safe position from which the switch actuating element can no longer be transferred by the actuator into a position in which the device signals the locked state of the safety device. In this fail-safe position of the switch actuating element, the device signals the unlocked state of the safety device.

Excessive force on the actuator can be exerted, for example, by the operating person in such a way that force is exerted when pulling on the safety door on which the actuator is mounted. In the case of the safety switches known from the prior art, such a situation may result in the movement of the switch actuating element into a position in which the no longer locked and also no longer closed state of the safety device is correctly signaled, but the safety switch is damaged. When the safety device is then subsequently closed, there is the risk that the damaged safety switch will no longer provide a 100% functional guarantee that the closed and optionally also the locked state can still be signaled. The result is that the control system that is arranged downstream of the safety switch cannot detect that the safety switch has been damaged by the forced actuation.

Subject to the influence of an unacceptably excessive force, the device according to the invention moves the switch actuating element into a fail-safe position, from which the switch actuating element can no longer be driven out solely on the grounds of a displacement of the actuator. In particular, in this fail-safe position the device signals the unlocked and optionally also the not-closed state of the safety device, irrespective of the position of the actuator and, thus, prevents the operation of the machine located inside the safety device. Hence, the device according to the invention guarantees a safe operating state of the machine.

In one embodiment, the switch actuating element is blocked in the fail-safe position and maintains this blocked position irrespective of the position of the actuator. To this end, the switch actuating element can be connected in a non-positive locking or positive locking manner to a blocking element that is mounted in the switch housing. One embodiment achieves a positive locking connection in that the switch actuating element or a section thereof can be displaced or deflected by the excessive force in such a way that the switch actuating element is in positive engagement with a blocking element that is mounted in a preferably stationary manner in the switch housing; and, as a result, the fail-safe position of the switch actuating element is blocked.

One embodiment achieves a force locking connection by the fact that the switch actuating element can be connected in a clamping manner to the blocking element, which does not allow any further movement of the switch actuating element, by the excessive force. To this end, the switch actuating element can exhibit a thickened section, in particular a thickened and preferably mushroom-head-shaped end section, to which the switch actuating element can be connected in a clamping manner to the blocking element.

In one embodiment, the blocking element is formed by a guide element for mounting the switch actuating element in the switch housing, said mounting being moveable, for example, linearly. The switch actuating element can be designed so as to be at least partially cylindrical, in particular circular cylindrically. For a moveable mounting, the switch housing can have a bearing sleeve or a bearing bushing that exhibits, preferably at the end face, at least one slit. When excessive force is exerted on the actuator, its end, which extends into a detent recess of a curved path, for example, in the closed and locked state, can be plastically deformed, in particular can be bent. This bending allows a section of the switch actuating element to be inserted into a slit of the bearing sleeve and to be secured there in a clamping manner in the fail-safe position.

In one embodiment, the switch actuating element exhibits a desired breaking point, at which a first section of the switch actuating element can be detached owing to the excessive force acting on the actuator. This detachment essentially can also occur when the device does not have a guard locking device. In one embodiment, however, the device has a guard locking device; and the first section is detached subject to the deactivation of the guard locking function, in particular by a force exerted on the device by the actuator, for example, when the actuator is pulled. Then the switch actuating element can first be deformed, in particular also plastically deformed, and then subsequently detached.

In one embodiment, a second remaining section of the switch actuating element can be secured in a clamping manner on the device, in particular can be secured in a clamping manner on the blocking element, as a consequence of the forces occurring during the detachment. The blocking element can be formed, for example, by a guide element, in particular a guide sleeve. Due to the detachment, it is possible, for example, for a ridge to form on the second section. This ridge can engage in a clamping manner with the blocking element, in particular with the guide element.

In one embodiment, owing to the position of the desired breaking point, the second section of the switch actuating element in the attached clamped state is in the fail-safe position in which the device signals the unlocked state of the safety device. This strategy prevents the device from signaling the locked state of the safety device owing to a renewed insertion of the actuator, even though the switch actuating element was damaged by the excessive force, in particular, the first section was detached.

In one embodiment, the switch actuating element is designed as a plurality of pieces and has a first detachable section and a second remaining section. Preferably, the desired breaking point is arranged by the transition from the first to the second section. In so doing, the second section can be screwed or clamped to the first section, in particular can be screwed together and then cemented.

In one embodiment, the device has an electric switch element with a positive opening contact; and in the fail-safe position of the switch actuating element the positive opening contact is opened. A control current for the machine disposed inside the safety device can be conveyed by way of the positive opening contact so that it is guaranteed that on opening the positive opening contact, the operation of the machine is interrupted. Basically, the positive opening contacts are constructed of the same elements as the switch with the normally open contacts. However, in the case of a positive opening contact the switching contacts are opened by the external force and especially when a spring, mounted in the switch element, breaks or when the contacts are worn. This so-called positive opening can be achieved by a positive locking, rigid connection between the switch plunger and the contact bridge. Preferably, the positive opening contacts do not have any resilient parts.

In one embodiment, the device has a cam disk that is mounted in a rotatable manner in the switch base housing, in particular in a switch head housing, which can be securely mounted on a switch base housing. This cam disk in turn forms a curved path, with which the switch actuating element is held in engagement. The curved path exhibits a contour that deviates from the circular shape, so that the switch actuating element, which is held in engagement with the cam disk in the radial direction, can assume different positions as a function of the angle of rotation of the cam disk; and, thus, as a function thereof, various contacts can be activated. The actuator in turn turns the cam disk. The abutment of the switch actuating element against the cam disk can be provided by a spring force and/or by a magnetic force. Insofar as the curved path of the cam disk exhibits detent recesses, the switch actuating element can also provide a guard locking operation in that the contact force provides that the switch actuating element snap locks into the detent recess, thus blocking the rotation of the cam disk.

In one embodiment, the guard locking device has an electromagnet, which is arranged coaxially to the switch actuating element. This feature makes it possible to achieve a design of the device that reduces, in particular, the amount of space required and is preferably extended in the longitudinal direction. Preferably, a coil of the electromagnet covers at least in sections the switch actuating element, which in turn can be designed as an armature of the electromagnet.

Other advantages, features, and details of the invention are specified in the dependent claims and the following description, which describes in detail a number of exemplary embodiments with reference to the drawings. Each of the features mentioned in the claims and in the description may be essential to the invention singly or in any combination.

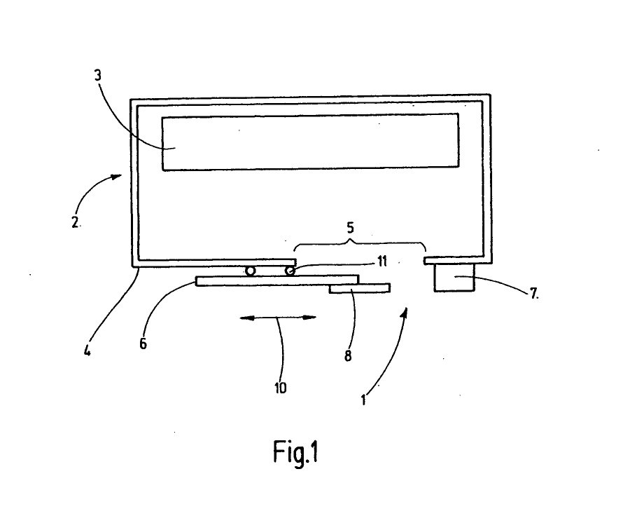

FIG. 1 shows a schematic top view of a whole configuration with a device according to the invention,

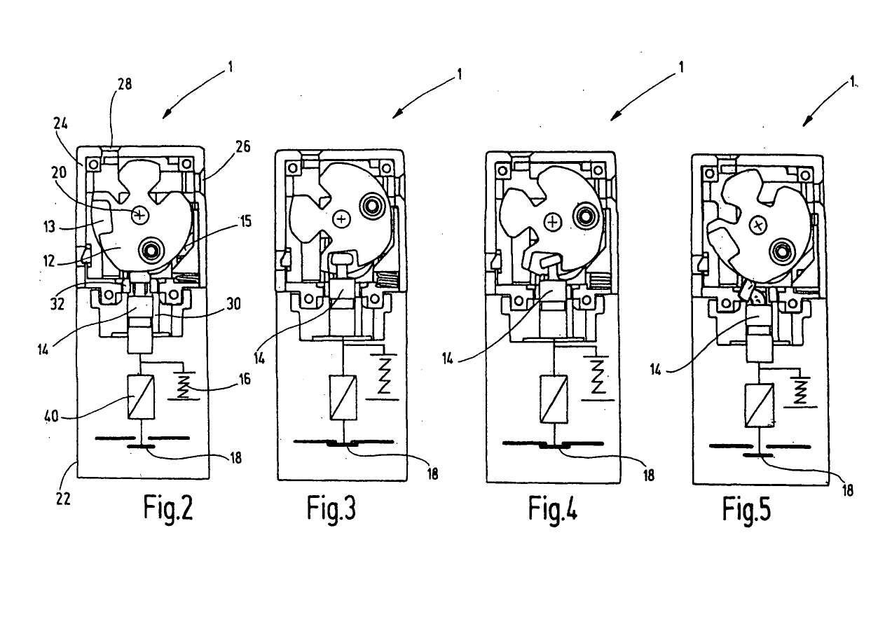

FIGS. 2 to 5 show an inventive device in four different states,

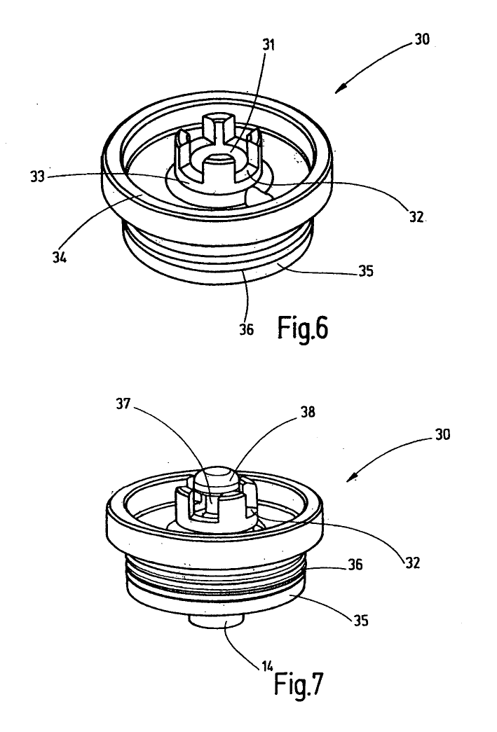

FIG. 6 shows a perspective view of the guide element,

FIG. 7 shows a perspective view of the guide element together with the switch actuating element,

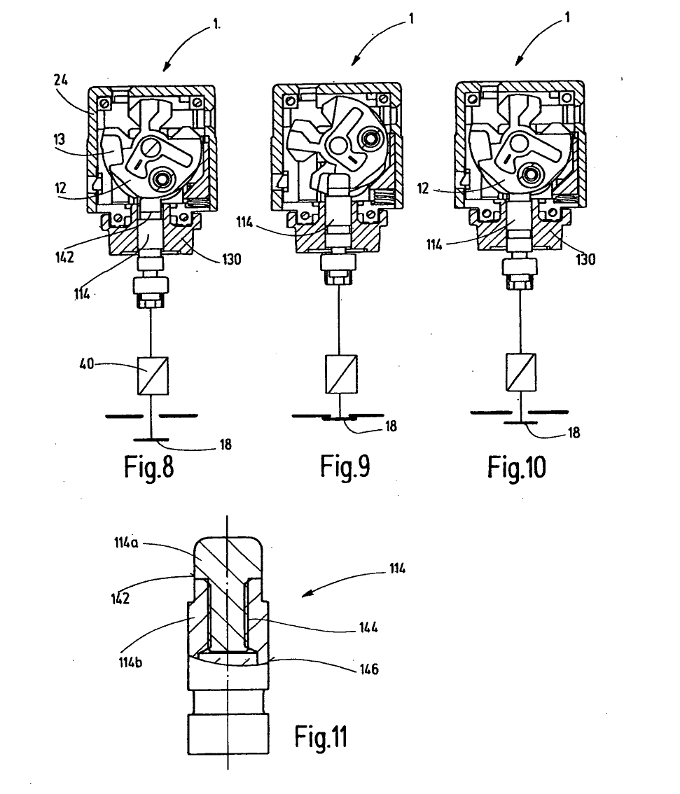

FIGS. 8 to 10 show a second embodiment of the inventive device in three different states, and

FIG. 11 shows an enlarged view of the end of the switch actuating element that faces the actuator.

FIG. 1 is a schematic top view of an overall configuration with an inventive device 1 for monitoring the state of the safety device 2 of a machine 3, in particular the closed state of a safety door, with which a space separating device can be closed, in order, for example, to protect the operating personnel from a potential danger arising from the machine 3 that is in operation. The safety device 2 has a first part 4, for example, a frame for the safety device 2. The first part 4 has an opening 5, which can be closed by a second part 6, for example, by a safety door, which can be moved relative to the first part 4 according to the double arrow 10 and is mounted in a moveable manner by means of the bearing elements 11. The device 1 has a safety switch, which comprises a switch element 7, which is mounted preferably on the stationary first part 4 of the safety device 2, and an actuator 8, which is mounted preferably on the moveable second part 6.

FIGS. 2 to 5 show an inventive device 1, which is provided for monitoring the state of the safety device 2 of the machine 4, in four different states. The device 1 has a switch base housing 22 that contains the electric switch element 7 of the device 1, of which the embodiment shows only the positive opening contact 18. A switch head housing 24 is attached in a detachable manner to the switch base housing 22. A cam disk 12, which is mounted in a rotatable manner around the axis of rotation 20, is disposed in said switch head housing.

The switch head housing 24 has two insert channels 26, 28, which extend at right angles to each other and are provided for the actuator 8 that is not shown in the FIGS. 2 to 5. The axial end of the switch actuating element 14 is held in radial engagement with the cam disk 12. Owing to the curved path 15, which deviates from the circular shape, the switch actuating element 14 is displaced in its longitudinal direction when the cam disk 12 is rotated. To this end, the switch actuating element 14 is guided in a linearly moveable manner in a guide element 30, which is disposed in the switch base housing 22 and has preferably at least in sections a hollow cylindrical shape. An energy accumulator 16 acts on the switch actuating element 14 in such a manner that it is held in engagement with the cam disk 12. An electromagnet 40, which can be supplied with current, can cancel the contact force of the energy accumulator 16.

FIG. 2 shows the device 1 in a state in which the safety device 2 is not closed and, therefore, the actuator 8 is not inserted into the switch head housing 24. In contrast, FIG. 3 shows the state of the device 1 in which the safety device 2 is closed and, thus, the (not illustrated) actuator 8 is inserted into the switch head housing 24; and the cam disk 12, leaving the starting position shown in FIG. 2, has rotated by about 90 degrees in a counter-clockwise direction. As a result, the detent groove 13, which is arranged on the outer peripheral surface of the cam disk 12, rotates into a position opposite the switch actuating element 14. Owing to the effect of the energy accumulator 16, the switch actuating element 14 snap locks into the detent groove 13 and, in so doing, closes the positive opening contact 18. In this state, the safety device 2 is locked by the device 1; and the machine 4, arranged inside the safety device 2, can be started up by a control system, arranged downstream of the device 1. The guard locking function is deactivated by the electromagnet 40, which, on being supplied with current, pulls the switch actuating element 14, as the armature of the electromagnet 40, out of the detent groove 13 against the effect of the energy accumulator 16.

FIG. 4 shows a state of the device 1 in which owing to the excessive force acting on the second part 6 of the safety device 2, for example, on the safety door, the actuator 8 and, thus, the cam disk 12, also exert a high force on the switch actuating element 14, by means of which the axial end of the switch actuating element 14 is deformed initially and, if desired, also resiliently, but then plastically during the subsequent course of events. In the state illustrated in FIG. 4, the switch actuating element 14 continues to remain in its position in which it locks the safety device 2 and, in so doing, locks the positive opening contact 18.

If the force continues to increase and, as a consequence thereof, the axial end of the switch actuating element 14 is further deformed, then this switch actuating element 14 is plastically deformed, as shown in FIG. 5. In particular, the situation will cause the switch actuating element 14 to disengage from the detent groove 13, whereupon then the actuator 8 can be pulled; and, consequently, the safety device 2 can be opened. This state is also reliably signaled by the opening of the positive opening contact 18.

The deformation of the switch activating element 14 causes its section, which is located axially at the end face, to engage in a clamping manner with a slit 32, configured on the axial end face of the guide element 30. As a result, the switch actuating element 14 is moved into a fail-safe position, from which the switch actuating element 14 can no longer be transferred by the actuator 8 into a position in which the device 1 signals the locked state of the safety device 2. Even if the safety device 2 is closed again, and, consequently, the actuator 8 enters again into the switch head housing 24 and, in so doing, rotates the cam disk 12 in such a way that the detent groove 13 lies opposite the switch actuating element 14, the clamping engagement of the switch actuating element 14 with the slit 32 prevents the switch actuating element 14 from closing once more the positive opening contact 18, because the spring force, generated by the energy accumulator 16, is not sufficient to cancel the clamping engagement of the switch actuating element 14 with the slit 32. The result is that even if the safety device 2 is closed once again and the cam disk 12 rotates properly, the device 1 still continues to remain in the fail-safe position and correctly signals the unlocked state of the safety device 2.

FIG. 6 is a perspective view of the guide element 30, of which the center exhibits a cylindrically hollow guide surface 31, constructed from an inner sleeve section 33, for the switch actuating element 14. The end face of the guide element 30 exhibits in the region of the guide surface 31a total of four slits 32, which are arranged so as to be offset relative to each other by an angle of 90 degrees, and which are machined into the inner sleeve section 33. The guide element 30 exhibits externally in the radial direction a ring 34. A connecting pin of the switch head housing 24 can be inserted into the ring shaped-receiving space between the inner sleeve section 33 and the ring 34. On a section facing the switch base housing 22, the guide element 30 has a sleeve-shaped section 35, of which the outside exhibits a serration 36 or also an external thread, with which the guide element 30 can be attached sealingly to the switch base housing 22.

FIG. 7 is a perspective view of the guide element together with the switch actuating element 14, of which the end section facing the switch head housing 24 exhibits a first section 37 having a smaller outer diameter and then a second section 38 having an outer diameter that is again larger. For this purpose, the first section 37 can be used to enable the plastic deformation to the extent that the second section 38 can be secured in a clamping manner in one of the slits 32 in such a way that the switch actuating element 14 does not break during this deformation.

FIGS. 8 to 10 show a second embodiment of the inventive device 1 in three different states. For the sake of clarity, the switch base housing is not shown, but can be constructed in a manner analogous to the switch base housing 22 of the first embodiment of FIGS. 2 to 5. The same applies to the energy accumulator 16.

FIG. 8 shows the device 1 in a state in which the safety device 2 is not closed and, therefore, the actuator 8 is not inserted into the switch head housing 24. In contrast, FIG. 9 shows the state of the device 1 in which the safety device 2 is closed and, thus, the actuator 8 is inserted into the switch head housing 24; and the cam disk 12, leaving the starting position shown in FIG. 8, has rotated by about 90 degrees in a counter-clockwise direction. As a result, the detent groove 13, which is arranged on the outer peripheral surface of the cam disk 12, is rotated into a position opposite the switch actuating element 114. Owing to the effect of the energy accumulator 16 (FIG. 2) which is not shown, the switch actuating element 114 snap locks into the detent groove 13 and, in so doing, closes the positive opening contact 18. In this state, the safety device 2 is locked by the device 1; and the machine 4, arranged inside the safety device 2, can be started up by a control system, arranged downstream of the device. The guard locking function is deactivated by the electromagnet 40, which, on being supplied with current, pulls the switch actuating element 114, as the armature of the electromagnet 40, out of the detent groove 13 against the effect of the energy accumulator 16.

FIG. 10 shows a state of the device 1 in which, owing to the excessive force acting on the second part 6 of the safety device 2, for example, on the safety door, the actuator 8 and, thus, the cam disk 12 also exert a high force on the switch actuating element 114, by means of which a first section 114a (FIG. 11) can be detached from the switch actuating element 114. In this respect, the detachment occurs at a desired breaking point 142, which is formed by a transition from the first section 114a to the second section 114b on the outer peripheral surface of the end section of the switch actuating element 114 that faces the switch wheel 12. This detachment causes the switch activating element 114 to disengage from the detent groove 13, whereupon the actuator 8 can be pulled and, thus, the safety device 2 can be opened. This state is also signaled by the opening of the positive opening contact 18, because the desired breaking point guarantees that the remaining section 114b is still long enough that when the remaining section 114b rests against the cam disk 12, the positive opening contact 18 remains open.

The forces which occur in the course of detaching the first section 114a and which are directed essentially at right angles to the longitudinal axis of the switch actuating element 114, and thus exert a force on the guide element 130, cause the remaining section 114b of the switch actuating element 114 to deform, with the result that said switch actuating element is clamped together with the guide element 130 in the position shown in FIG. 10. Even if the safety device 2 is closed and, as a result, the actuator 8 rotates anew the cam disk 12 into the position shown in FIG. 9, the switch actuating element 114 remains in the position shown in FIG. 10 and, thus, the device 1 signals the unlocked state of the safety device 2.

FIG. 11 is an enlarged view of the end of the switch actuating element 114 that faces the actuator. The first section 114a is a body that is at least partly cylindrical and exhibits, in particular, two subsections. A first subsection facing the second section 114b exhibits an external thread, with which the first section 114a can be screwed into an associated threaded borehole of the second section 114b. In one embodiment, the two sections 114a, 114b are then also cemented together.

The second section 114b in turn is configured so as to be partly cylindrical and exhibits, in particular, a cylindrical outer surface 146, with which the switch actuating element 114 is guided in an axially moveable manner in the guide element 130. In close proximity to the end facing the first section 114a, the second section 114b tapers off in a pin-like manner, with the external diameter in the tapered end section coinciding with the external diameter of the second subsection of the first section 114a, so that the transition from the first section 114a to the second section 114b is flush.

1. A device (1) for monitoring the state of a safety device (2) on a machine (4), in particular a safety switch for monitoring the closed state of a safety door or the like, wherein the device (1) has a switch housing (22, 24) and an actuator (8), which in the closed state of the safety device (2) interacts with a switch actuating element (14), which is mounted in a moveable manner in the switch housing (22, 24), and, thus, the closed state of the safety device (2) can be signaled, and wherein the device (1) has a guard locking device, by means of which the closed state of the safety device (2) can be locked in a releasable manner, characterized in that by applying excessive force to the actuator (8) against the effect of the guard locking device, the switch actuating element (14) can be moved into a fail-safe position, from which the switch actuating element (14) can no longer be transferred by the actuator (8) into a position in which the device (1) signals the locked state of the safety device (2), and that in this fail-safe position of the switch actuating element, the device (1) signals the unlocked state of the safety device (2).

2. The device (1) according to claim 1, characterized in that the switch actuating element (14) is blocked in the fail-safe position and maintains this blocked position irrespective of the position of the actuator (8).

3. The device (1) according to claim 1, characterized in that in the fail-safe position the switch actuating element (14) is connected in a non-positive locking and/or positive locking manner to a blocking element that is arranged in the switch housing (22, 24).

4. The device (1) according to claim 3, characterized in that owing to the excessive force on the actuator (8), the switch actuating element (14) can be connected in a clamping manner to the blocking element.

5. The device (1) according to claim 4, characterized in that the switch actuating element (14) exhibits a thickened section, in particular a thickened end section, to which the switch actuating element (14) can be connected in a clamping manner to the blocking element.

6. The device (1) according to claim 3, characterized in that the blocking element is formed by a guide element (30) for the moveable mounting of the switch actuating element (14).

7. The device (1) according to any claim 3, characterized in that the blocking element is formed by a sleeve that exhibits, preferably, at the end face, at least one slit (32), and that in the fail-safe position the switch actuating element (14) is inserted into a slit (32) and is secured there in a clamping manner.

8. The device (1) according to claim 1, characterized in that owing to the excessive force on the actuator (8), the switch actuating element (14) can be plastically deformed.

9. The device (1) according to claim 1, characterized in that the switch actuating element (14) exhibits a desired breaking point at which a first section of the switch actuating element (14) can be detached owing to the excessive force acting on the actuator (8).

10. The device (1) according to claim 9, characterized in that as a consequence of the forces that occur in the course of the detachment, a second section of the switch actuating element (14) can be attached in a clamping manner, in particular can be attached in a clamping manner to the blocking element.

11. The device (1) according to claim 10, characterized in that owing to the position of the desired breaking force, the second section of the switch actuating element (14) in the attached clamped state is in the fail-safe position in which the device (1) signals the unlocked state of the safety device (2).

12. The device (1) according to any claim 9, characterized in that the switch actuating element (14) is designed as a plurality of pieces, and that the transition from the first detachable section to the second remaining section forms a desired breaking point.

13. The device (1) according to claim 1, characterized in that the device (1) has an electric switch element with a positive opening contact (18), and that in the fail-safe position of the switch actuating element (14), the positive opening contact (18) is opened.

14. The device (1) according to any claim 1, characterized in that the device (1) has a cam disk (12) with which the switch actuating element (14) is held in engagement, and that said cam disk is mounted in a rotatable manner in the switch housing (22, 24), in particular in a switch head housing (24), which can be securely mounted on a switch base housing (22).

15. The device (1) according to claim 1, characterized in that the guard locking device has an electromagnet (40), and that the electromagnet (40) is arranged coaxially to the switch actuating element (14).

16. The device (1) according to claim 1, characterized in that the switch actuating element (14) forms at least in sections an armature of the electromagnet (40) of the guard locking device.
